(19) United States
(12) Patent Application Publication
(10) Pub. No.: US 2023/0034104 A1
(43) Pub. Date: Feb. 2, 2023

(54) METHOD FOR PULVERIZING A WASTE MAGNET AND A WASTE MAGNET POWDER PRODUCED USING THE METHOD

(71) Applicants: HYUNDAI MOTOR COMPANY, Seoul (KR); KIA CORPORATION, Seoul (KR); SUNG LIM RARE EARTH METAL, CO., LTD, Daegu (KR)

(72) Inventors: Bo Kyeong Han, Hwaseong-si (KR); Byung Chul Lim, Daegu (KR)

(73) Assignees: HYUNDAI MOTOR COMPANY, Seoul (KR); KIA CORPORATION, Seoul (KR); SUNG LIM RARE EARTH METAL, CO., LTD, Daegu (KR)

(21) Appl. No.: 17/507,682

(22) Filed: Oct. 21, 2021

(30) Foreign Application Priority Data
Jul. 20, 2021 (KR) 10-2021-0094927

(51) Int. Cl. H01F 1/057; H01F 41/02; C22C 38/00

(52) U.S. Cl. CPC H01F 1/0577; H01F 1/0573; H01F 41/0293; C22C 38/005

(57) ABSTRACT

Disclosed are a method for pulverizing a waste magnet and a waste magnet powder produced by the method. More particularly, disclosed is a method for efficiently producing a waste magnet powder having a small average particle size by pulverizing a raw material containing a hydrogen-occluded rare earth metal before dehydrogenation of the raw material.

### CROSS-REFERENCE TO RELATED APPLICATION

This application claims under 35 U.S.C. § 119(a) the benefit of priority to Korean Patent Application No. 10-2021-0094927, filed on Jul. 20, 2021, the entire contents of which are incorporated herein by reference.

### BACKGROUND

### (a) Technical Field

The present disclosure relates to a method for pulverizing a waste magnet and a waste magnet powder produced by the method, and more particularly, to a method for efficiently producing a waste magnet powder having a small average particle size by pulverizing a raw material containing a hydrogen-occluded rare earth metal before dehydrogenation of the raw material.

### (b) Background Art

Among various magnets, a neodymium-iron-boron magnet, which is a high-performance rare-earth magnet, is used in various electronic devices due to the production of the greatest amount of magnetic energy and the relatively low price thereof. In addition, rare earth magnets may be recovered and reused from exhausted electronic devices. In general, such recovered rare earth magnets are subjected to a mechanical pulverization process using a roll mill, a vibration mill, and the like, and are processed into waste magnet powder having an average particle size of about 800 μm.

There is hydrogen damage (HD) fracturing as another method, which is pulverization using absorption and desorption of hydrogen, and includes absorbing hydrogen to form a hydride, desorbing the hydrogen to return the hydride to the state of a metal having fine cracks, and pulverizing the metal. In this case as well, it is possible to obtain a waste magnet powder having an average particle size of about 500 μm, but it is difficult to obtain a waste magnet powder having an average particle size of 100 μm or less.

When a powder having an average particle size of 100 μm or more is present in the waste magnet powder obtained through the methods above, there is a problem in that process efficiency is greatly reduced in the oxidizing, roasting, and leaching steps during a recycling process.

In general, in order to dissolve neodymium (Nd) rather than iron (Fe) contained in the waste magnet powder, the oxidizing roasting induces a phase change from Nd₂Fe₁₄B, the main phase of the waste magnet powder, into Fe₂O₃ and Nd₂O₃. When the particle size of the waste magnet powder is 100 μm or more, oxidation is induced by heat treatment at a high temperature for a long time to induce a phase change in the inside of the particles as well. This disadvantageously increases energy consumption and processing time, resulting in increased process costs and decreased productivity. In addition, when the particle size of the waste magnet powder exceeds 100 μm during leaching as well as oxidizing roasting, it is difficult to dissolve the rare-earth atoms in the particles, making it difficult to achieve a recovery rate of 80% of the rare-earth atoms. In order to completely dissolve the rare earth elements in the particles, it is necessary to increase the acid concentration, increase the reaction temperature, increase the reaction time, and the like. When a recovery rate of more than 90% is achieved in this way, it is difficult to suppress the dissolution of iron (Fe) during processing, so an additional process is required to remove iron in subsequent processing, thus undesirably increasing process costs.

Therefore, it is most important to obtain a waste magnet powder having a particle size of 100 μm or less in order to achieve a rare-earth element recovery rate of 90% or more and to provide an advantage in terms of process costs.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is one object of the present disclosure to provide a method for obtaining a waste magnet powder having an average particle size of 100 μm or less from a waste magnet.

It is another object of the present disclosure to provide a method capable of reducing the pulverization time taken to pulverize a waste magnet.

It is another object of the present disclosure to provide a method capable of reducing the time and expense incurred by a process for recycling rare earth elements from the waste magnet.

It is another object of the present disclosure to provide a waste magnet powder having an average particle size of 100 μm or less.

The objects of the present disclosure are not limited to those described above. Other objects of the present disclosure are clearly understood from the following description, and are able to be implemented as defined in the claims and combinations thereof.

In one aspect, the present disclosure provides a method of pulverizing a waste magnet, the method including forming a hydride by occluding hydrogen in a raw material containing a rare earth metal, pulverizing the raw material containing the hydride, and dehydrogenating the raw material by heating, where the rare earth metal includes neodymium (Nd), iron (Fe), and boron (B), and the hydride includes neodymium (Nd), iron (Fe), boron (B), and hydrogen (H).

The raw material may be occluded by supplying the hydrogen to the raw material at a partial pressure of 0.1 to 5 atm.

The raw material may be occluded by supplying the hydrogen to the raw material at a temperature of 25 to 400° C.

The raw material may be occluded by supplying the hydrogen to the raw material for 1 to 50 hours.

The raw material containing the hydride may be pulverized in a rotary kneader.

The kneader may rotate at a rate of 4 rpm or more.

The raw material containing the hydride may be pulverized by supplying milling balls to the kneader.

The milling balls may be formed of at least one of stainless steel, tungsten, molybdenum, alumina, or zirconia.

The milling balls may have a particle diameter of ø5 to ø50.

The weight ratio of the milling balls to the raw material may be 1:2 to 10:1.

The dehydrogenation may be performed by heating the raw material to a temperature of 400 to 650° C.

In another aspect, the present disclosure provides a waste magnet powder prepared by the method described above.

The waste magnet powder may have an average particle size of 5 to 30 μm.

Other aspects and embodiments of the disclosure are discussed below.

### DETAILED DESCRIPTION

The objects described above, as well as other objects, features and advantages, are clearly understood from the following embodiments with reference to the attached drawings. However, the present disclosure is not limited to the embodiments and may be embodied in different forms. The embodiments are suggested only to offer a thorough and complete understanding of the disclosed context and to sufficiently inform those having ordinary skill in the art of the technical concept of the present disclosure.

Like reference numbers refer to like elements throughout the description of the figures. In the drawings, the sizes of structures may be exaggerated for clarity. It is understood that, although the terms “first”, “second”, and the like may be used herein to describe various elements, these elements should not be construed as being limited by these terms, which are used only to distinguish one element from another. For example, within the scope defined by the present disclosure, a “first” element may be referred to as a “second” element, and similarly, a “second” element may be referred to as a “first” element. Singular forms are intended to include the plural meaning as well, unless the context clearly indicates otherwise.

It is further understood that the term “comprises”, “has” or the like, when used in this specification, specifies the presence of stated features, integers, steps, operations, elements, components or combinations thereof, but does not preclude the presence or addition of one or more other features, integers, steps, operations, elements, components, or combinations thereof. In addition, it is understood that, when an element such as a layer, film, region or substrate is referred to as being “on” another element, it can be directly on the other element, or an intervening element may also be present. It is also understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum, including the maximum within the range, unless otherwise defined.

It should be understood that, in the specification, when a range is referred to regarding a parameter, the parameter encompasses all figures including end points disclosed within the range. For example, the range of “5 to 10” includes figures of 5, 6, 7, 8, 9, and 10, as well as arbitrary sub-ranges, such as ranges of 6 to 10, 7 to 10, 6 to 9, and 7 to 9, and any figures, such as 5.5, 6.5, 7.5, 5.5 to 8.5 and 6.5 to 9, between appropriate integers that fall within the range. In addition, for example, the range of “10% to 30%” encompasses all integers that include numbers such as 10%, 11%, 12% and 13%, as well as 30%, and any sub-ranges, such as 10% to 15%, 12% to 18%, or 20% to 30%, as well as any numbers, such as 10.5%, 15.5% and 25.5%, between appropriate integers that fall within the range.

The present disclosure relates to a method for pulverizing a waste magnet and a waste magnet powder produced by the method, and more particularly, to a method for efficiently producing a waste magnet powder having a small average particle size by pulverizing raw materials containing a hydrogen-occluded rare earth metal before dehydrogenation of the raw materials.

Hereinafter, the method for pulverizing a waste magnet and a waste magnet powder produced by the method according to the present disclosure is described in detail.

Waste Magnet Pulverization Method

The method of pulverizing a waste magnet according to the present disclosure includes forming a hydride by occluding hydrogen in a raw material containing a rare earth metal, pulverizing the raw material containing the hydride, and dehydrogenating the raw material by heating. Hereinafter, each step is described.

Hydride Formation

In this step, a hydride is formed by occluding hydrogen in a raw material containing a rare earth metal.

The rare earth metal of the present disclosure includes neodymium (Nd), iron (Fe), and boron (B). A compound containing neodymium, iron, and boron is converted into a hydride by adding hydrogen to the rare earth metal.

The hydride may contain neodymium (Nd), iron (Fe), boron (B), and hydrogen (H).

The rare earth metal may include a Nd₂Fe₁₄B compound, and the hydride may include Nd₂Fe₁₄B.Hₓ.

The hydrogen may be supplied to the raw material at a partial pressure of 0.1 to 5 atm. The hydride reaction of rare earth elements proceeds spontaneously, so there is no problem in forming a hydride even if the partial pressure of hydrogen is small. However, when the partial pressure of hydrogen is higher than 5 atm, there is a risk of deterioration of work stability.

The hydrogen may be supplied to the raw material at a temperature of 25 to 400° C. and allowed to react. However, when the temperature exceeds 400° C., the hydrogen may be desorbed from the hydride. Thus, in one example the temperature for the hydrogen reaction may be adjusted to 400° C. or less.

The hydrogen may be supplied to the raw material for 1 to 50 hours. In this case, when the hydrogen is supplied for a time shorter than 1 hour, the reaction may not proceed well. When the hydrogen is supplied for a time longer than 50 hours, disadvantageously, economic efficiency is lost.

Pulverization

In this step, the raw material containing the hydride is pulverized.

The hydride produced by the occlusion of hydrogen may be very brittle and thus may be pulverized into a fine powder even through application of a small impact thereto. The pulverization of the formed hydride may be performed based on the above characteristics. The pulverization may be performed by a kneader that pulverizes the raw material while rotating. In other words, the raw material containing the hydride may be fed to a rotary kneader and pulverized therein.

The kneader may be rotated at a rate of 4 rpm or more. At a rate of less than 4 rpm, the pulverization time may be prolonged, and thus economic feasibility may be deteriorated.

Milling balls may further be added to the kneader together with the raw material. The milling balls rotate together with the raw material in the kneader and apply an impact to the raw material to facilitate pulverization of the raw material. The milling balls may be formed of any one material of stainless steel, tungsten, molybdenum, alumina, or zirconia.

The particle diameter of the milling balls may be ø5 to ø50 (i.e., diameter size of 5 μm to 50 μm). When the diameter of the milling balls is excessively small, pulverization efficiency may be lowered. When the particle diameter thereof exceeds ø50, the frequency of impact for pulverization decreases and pulverization may not proceed properly.

The weight ratio of the milling balls to the raw material may be 1:2 to 10:1. In this case, when the weight of the milling balls is increased more than necessary compared to the raw material, the yield may decrease. When the weight of the milling balls is decreased more than necessary compared to the raw material, the frequency of application of impact decreases, the pulverization processing time increases, and economic efficiency decreases.

Dehydrogenation

In this step, the raw material is dehydrogenated by heating. More specifically, in one example, hydrogen is removed from a Nd₂Fe₁₄B.Hₓ compound by heating the raw material containing the hydride to a temperature of 400° C. to 650° C. When the dehydrogenation time is excessively lengthened at a temperature of 400° C. or less, and at a temperature higher than 650° C., a phase change occurs, and the dehydrogenation does not occur.

Waste Magnet Powder

The waste magnet powder obtained through the waste magnet pulverization method according to the present disclosure contains a Nd₂Fe₁₄B compound and has an average particle size of 100 μm or less, such as, for example, 5 to 30 μm.

Hereinafter, the present disclosure is described in more detail with reference to specific examples. However, the following examples are provided only for better understanding of the present disclosure, and thus should not be construed as limiting the scope of the present disclosure.

### Production Example

A waste magnet recovered from a waste motor was crushed in a jaw crusher, the crushed waste magnet was placed together with milling balls in a kneader, and then hydrogen was injected and was allowed to react while rotating the kneader. Then, the resulting product was dehydrogenated by heating and allowed to cool to room temperature to obtain a waste magnet powder.

### Examples and Comparative Examples

Waste magnet powders were prepared in accordance with the production example above under the conditions shown in Table 1 below:

TABLE 1

| | | | Comp. | Comp. | Comp. | Comp. | Comp. | Comp. |
|---|---|---|---|---|---|---|---|---|
| | Ex. 1 | Ex. 2 | Ex. 1 | Ex. 2 | Ex. 3 | Ex. 4 | Ex. 5 | Ex. 6 |
| Hydrogen | 1 | 3 | — | 1 | 1 | 1 | 1 | 1 |
| partial pressure | | | | | | | | |
| (atm) | | | | | | | | |
| Milling ball | 10 | 30 | 10 | 1 | 80 | 10 | 10 | 10 |
| size (ø) | | | | | | | | |
| Hydrogenation | 200 | 300 | 200 | 200 | 200 | 500 | 200 | 200 |
| temperature (° C.) | | | | | | | | |
| Hydrogenation | 2 | 4 | 2 | 2 | 2 | 2 | 0.5 | 2 |
| time (hr) | | | | | | | | |
| Kneader rotation | 4 | 5 | 4 | 4 | 4 | 4 | 4 | 4 |
| rate (rpm) | | | | | | | | |
| Weight ratio | 1:1 | 1:4 | 1:1 | 1:1 | 1:1 | 1:1 | 1:1 | 12:1 |
| of milling balls to | | | | | | | | |
| raw material | | | | | | | | |

### Comparative Example 7

For Comparative Example 7, a waste magnet powder was prepared in the same manner as in Example 1 above, except that hydrogen was injected into the crushed waste magnet and was allowed to react, followed by dehydrogenation and then pulverization in a kneader.

### Experimental Examples

The average particle sizes of the waste magnet powders obtained in Examples 1 and 2 and Comparative Examples 1-7 are shown in Table 2 below. Roasting and leaching were performed on the waste magnet powders obtained in the Examples and Comparative Examples, and the roasting efficiency and the recovery rate during the leaching are shown in Tables 3 and 4, respectively.

TABLE 2

| | | | Comp. | Comp. | Comp. | Comp. | Comp. | Comp. | Comp. |
|---|---|---|---|---|---|---|---|---|---|
| | Ex. 1 | Ex. 2 | Ex. 1 | Ex. 2 | Ex. 3 | Ex. 4 | Ex. 5 | Ex. 6 | Ex. 7 |
| Average | 12.2 | 2.1 | 341 | 154 | 103 | 257 | 201 | 109.5 | 368 |
| particle | | | | | | | | | |
| size (μm) | | | | | | | | | |

As can be seen from the results of Table 2, Comparative Example 1 exhibited a large particle size because a hydride was not formed well due to an insufficient partial pressure of hydrogen. Comparative Example 4 exhibited a large particle size because some of the occluded hydrogen was desorbed during heating at the reaction temperature due to the excessively high hydrogenation temperature and thus a hydride was not sufficiently formed. Comparative Example 5 exhibited a large particle size because a hydride was not sufficiently formed due to the excessively short hydrogenation time. Comparative Example 7 exhibited a large particle size because either little very brittle hydride or no very brittle hydride was produced, i.e., hydride reverted to the Nd₂Fe₁₄B compound through dehydrogenation, and thus the pulverization effect using the balls was deteriorated.

Comparative Example 2 is considered to exhibit a large average particle size because the ball size was excessively small and the pulverization effect due to the impact therewith was decreased.

Comparative Example 3 is considered to exhibit a large average particle size because the weight of the balls excessively increased and the number of balls decreased as the size of the balls increased.

Comparative Example 6 is considered to exhibit a large particle size because the uniformity of pulverization was lowered due to the excessively small weight ratio of the balls to the raw material.

TABLE 3

| | | | Comp. | Comp. | Comp. | Comp. | Comp. | Comp. | Comp. |
|---|---|---|---|---|---|---|---|---|---|
| | Ex. 1 | Ex. 2 | Ex. 1 | Ex. 2 | Ex. 3 | Ex. 4 | Ex. 5 | Ex. 6 | Ex. 7 |
| Roasting | 100 | 100 | 45 | 75 | 60 | 57 | 72 | 82 | 51 |
| efficiency (%) | | | | | | | | | |

* Measurement method = The produced magnet powder was treated in a reactor rotating at 2 rpm in an environment exposed to the air rather than being directly treated in atmosphere and the treatment temperature was set to 650° C..
*Roasting efficiency calculation method = Nd and Fe are oxidized to Nd₂O₃ and Fe₂O₃. Oxidization at 100% caused a weight increase of 130%. The roasting efficiency was calculated as actual weight increase/theoretical weight increase (130%).

As can be seen from the results of Table 3, most of the roasting efficiencies of the Comparative Examples, excluding Examples 1 and 2, are low.

TABLE 4

| | | | Comp. | Comp. | Comp. | Comp. | Comp. | Comp. | Comp. |
|---|---|---|---|---|---|---|---|---|---|
| | Ex. 1 | Ex. 2 | Ex. 1 | Ex. 2 | Ex. 3 | Ex. 4 | Ex. 5 | Ex. 6 | Ex. 7 |
| % Fe | 38 | 27 | 85 | 81 | 76 | 92 | 72 | 82 | 85 |
| Pr | 95 | 93 | 75 | 77 | 74 | 84 | 71 | 81 | 77 |
| Nd | 97 | 95 | 89 | 86 | 84 | 91 | 76 | 87 | 79 |
| Dy | 94 | 90 | 71 | 82 | 83 | 86 | 69 | 86 | 65 |

*Measurement method = Each roasted magnetic powder was leached in 1M sulfuric acid at a reaction temperature of 65° C. for a reaction time of 3 hours. Then, the leachate was filtered and the filtrate was analyzed by ICP to calculate the recovery rate.
* Recovery rate calculation method = Amount of each leached element/amount of each input element

Examples 1 and 2 exhibited a high recovery rate of rare earth elements while moderately suppressing the leaching of Fe, whereas the Comparative Examples exhibited low recovery rates of rare earth elements due to the difficulty in dissolving the inside of the particles attributed to the large particle size. In addition, it may be considered that, because the roasting efficiency is low due to the large particle size, not 100% of Fe is oxidized, but some is present in an Fe alloy form, so Fe is dissolved before Nd oxide, and it is thus difficult to suppress the dissolution of Fe.

As is apparent from the foregoing, the present disclosure is capable of providing a method for obtaining a waste magnet powder having an average particle size of 100 μm or less from a waste magnet.

The present disclosure is capable of providing a method capable of reducing a pulverization time taken to pulverize a waste magnet.

The present disclosure is capable of providing a method of reducing the time and expense incurred by a process for recycling rare earth elements from the waste magnet.

The present disclosure is capable of providing a waste magnet powder having an average particle size of 100 μm or less.

The effects of the present disclosure are not limited to those mentioned above. It should be understood that the effects of the present disclosure include all effects that can be inferred from the description of the present disclosure.

The present disclosure has been described in detail with reference to embodiments thereof. However, it is appreciated by those having ordinary skill in the art that changes may be made in these embodiments without departing from the principles and spirit of the present disclosure, the scope of which is defined in the appended claims and their equivalents.

What is claimed is:

1. A method of pulverizing a waste magnet, the method comprising:
forming a hydride by occluding hydrogen in a raw material containing a rare earth metal;
pulverizing the raw material containing the hydride; and
dehydrogenating the raw material by heating,
wherein the rare earth metal comprises neodymium (Nd), iron (Fe), and boron (B), and
the hydride comprises neodymium (Nd), iron (Fe), boron (B), and hydrogen (H).

2. The method according to claim 1, wherein the raw material is occluded by supplying the hydrogen to the raw material at a partial pressure of 0.1 to 5 atm.

3. The method according to claim 1, wherein the raw material is occluded by supplying the hydrogen to the raw material at a temperature of 25 to 400° C.

4. The method according to claim 1, wherein the raw material is occluded by supplying the hydrogen to the raw material for 1 to 50 hours.

5. The method according to claim 1, wherein the raw material containing the hydride is pulverized in a rotary kneader.

6. The method according to claim 5, wherein the kneader rotates at a rate of 4 rpm or more.

7. The method according to claim 5, wherein the raw material containing the hydride is pulverized by supplying milling balls to the kneader.

8. The method according to claim 7, wherein the milling balls are formed of at least one of stainless steel, tungsten, molybdenum, alumina, or zirconia.

9. The method according to claim 7, wherein the milling balls have a particle diameter of ø5 to ø50.

10. The method according to claim 7, wherein a weight ratio of the milling balls to the raw material is 1:2 to 10:1.

11. The method according to claim 1, wherein the dehydrogenation is performed by heating the raw material to a temperature of 400 to 650° C.

12. A waste magnet powder prepared by the method according to claim 1.

13. The waste magnet powder according to claim 12, wherein the waste magnet powder has an average particle size of 5 to 30 μm.
